(19) United States
(12) Patent Application Publication
(10) Pub. No.: US 2021/0277819 A1
(43) Pub. Date: Sep. 9, 2021

(54) IGNITION PISTON

(71) Applicant: Victor Rudolph Bloomquist, Brush Prairie, WA (US)

(72) Inventor: Victor Rudolph Bloomquist, Brush Prairie, WA (US)

(21) Appl. No.: 16/873,251

(22) Filed: Mar. 6, 2020

(51) Int. Cl. F02B 1/12; F02B 75/28

(52) U.S. Cl. CPC F02B 1/12; F02B 75/28

(57) ABSTRACT

The ability of the ignition piston engine is to use the disel technic of igniting the fuel air mixture by compression with out using an injector. The ignition piston engine can burn a leaner air fuel mixture than any other engine there by giving a cleaner exhaust and more economy. The ignition piston engine can burn any type of fuel that flows in air and is combustable by heat; like gasolene, diesel, propane, natural gas, and kerosene in any desired air fuel mix. And it can do it with out using a spark plug.

It is an internal combustion engine using two pistons operating in two different cylinders; the cylinders are parallel; the cylinders are adjacent to each other; one cylinder is smaller than the other; the smaller piston is operating in the smaller cylinder 13 and it is the ignition piston 1; the larger piston 2 is operating in the larger cylinder 14; both pistons are operated by the same crankshaft 17; the crankshaft 17 has the two conrod journals 15 and 16 side by side sixteen degrees apart; the smaller ignition piston crankshaft conrod journal 15 is eight degrees before top dead center (TDC); the larger piston crankshaft conrod journal 16 is eight degrees after TDC; at pnthis rotational position of the crankshaft 17 the smaller ignition piston 1 is compressing the air-fuel mixture to combustion; at combustion, the pressure in the small piston combustion chamber 10 opens relief valve 3 in the head 11; the relief valve 3 opens channel 8 in the head 11 between the small ignition piston 1 and the larger low compression piston combustion chamber 9; the high pressured burning air fuel mixture is forced into the lower pressure large piston combustion chamber 9; thus igniting the air fuel mixture in the large piston combustion chamber 9.

### DESCRIPTION

My new design on the small piston conrod 18 puts the torque past the TDC of the crankshaft 17 when the crankshaft conrod journal 15 is eight degrees before TDC; the down thrust of conrod 18 has no support except for thrust rod 26; thrust rod 26 uses pins to mount it to conrod 18; thrust rod hole 25 is connected to conrod hole 22 by a pin and hole 24 is connected to hole 23 by a pin thus mounting the thrust rod 26 to the conrod 18; conrod 18 has no vertical support on the bottom end because space 21 is just open space; because conrod 18 has no down motion support except thrust rod 26; thrust rod 26 receives the piston thrust; thrust rod 26 puts the thrust on to pinhole 23 of receptacle 19 past top dead center.

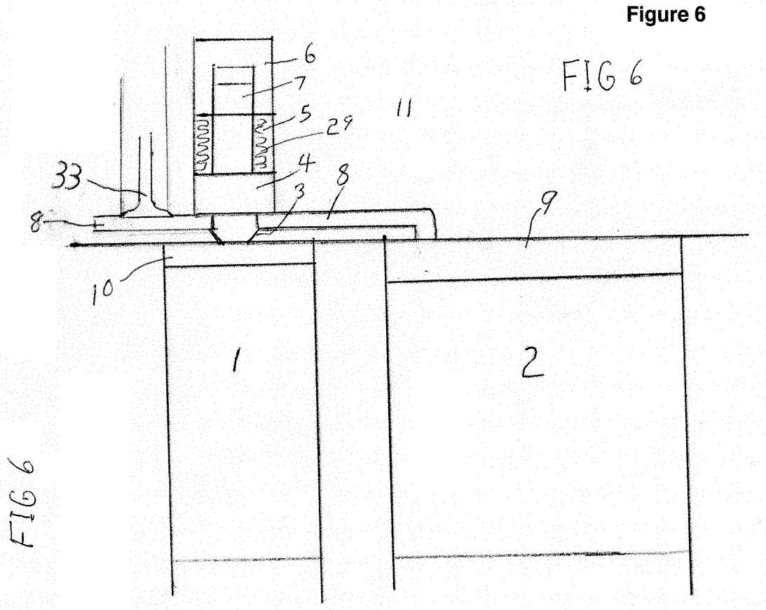

There are many relief valves all-ready-made so it is a matter of which one an engine maker will choose; the one I thought of has a main shaft 7; one end of shaft 7 is the seal area between the combustion chamber 10 and the ignition channel 8; piston 4 is securely attached to shaft 7; piston 4 has compression rings and an oil ring; area 5 is where the pressure adjusting spring is compressed between piston 4 and adjusting cylinder 6; adjusting cylinder 6 is adjusted by a nut on a threaded shaft; nut and threaded shaft not shown. In addition in my afterthoughts another optional use of my relief valve, with added parts, is the timing of the combustion on the ignition piston. Figure five shows a camshaft 31 which relieves pressure on the relief valve pressure adjusting cylinder 6 when the cam side is up; this releasing the pressure on spring 29 this allowing the air-fuel mixture to escape into channel 8 in the first part of the compression stroke of the ignition piston 1; then the cam 32 comes around and pushes adjusting cylinder 6 down compressing spring 29 closing the valve 3; the closing of valve 3 is done when there is just the right amount of volume of the fuel-air mixture in the combustion chamber 10; this is done so that when the ignition piston 1 reaches the top dead center, or a little before, it has combustion pressure and not before; thus preventing combustion pressure too early in the compression stroke and preventing precombustion. The timing relief valve would not be needed if the ignition piston stroke did not compress the air-fuel mixture to combustion before the top dead center. Another way of using the relief valve to time the engine is; just air with no fuel sucked into chamber 10 on the intake stroke; then compressing the air to high combustion heat on the compression stroke; then have a controlled timing opening of the relief valve 3; this letting high-pressure high combustion heated air into channel 8; channel 8 being filled with fuel-air mixture received through intake valve 33; this hot air igniting the fuel-air mixture; this explosion of fire goes into chamber 10 and chamber 9 driving both piston 1 and igniting the air-fuel mixture in chamber 9. A drawing of this timing is FIG. 6.

### NAMES AND NUMBERS OF PARTS

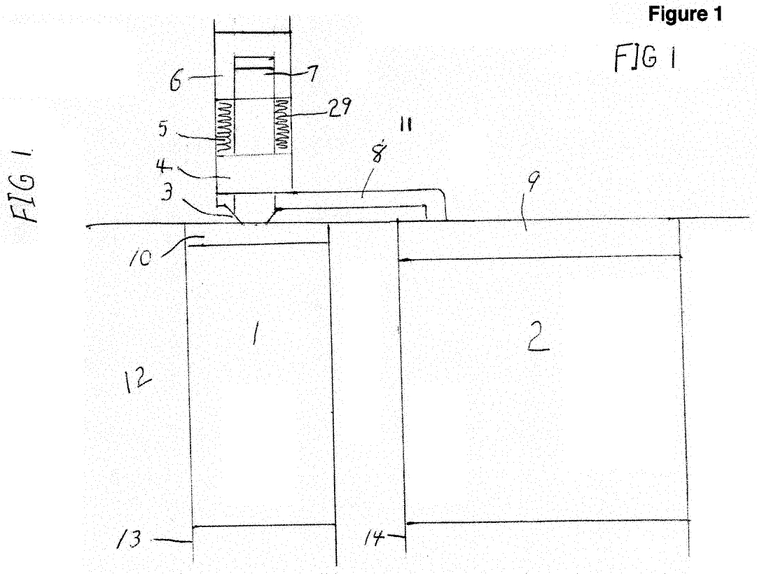

FIG. 1:
1 ignition piston
2 larger piston
3 relief valve
4 relief valve piston
5 relief valve pressure spring compartment
6 relief valve pressure adjusting cylinder
7 relief valve main shaft
8 ignition fire channel
9 large piston combustion chamber
10 ignition piston combustion chamber
11 engine head
12 engine block
13 ignition piston cylinder
14 larger piston cylinder

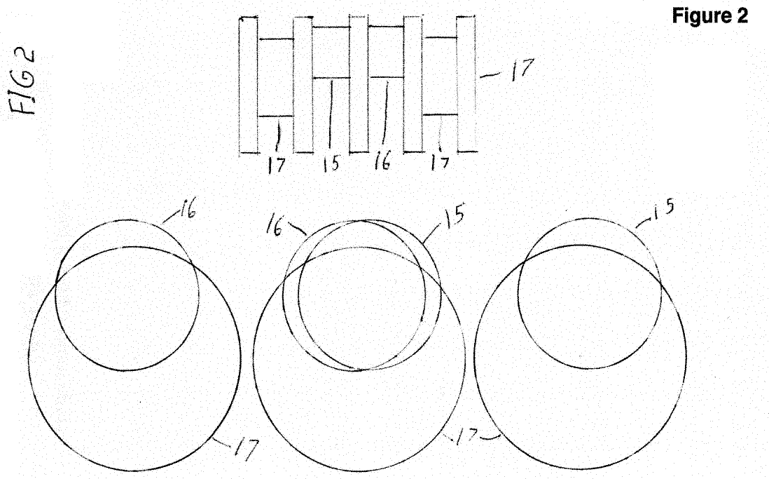

FIG. 2:
15 ignition piston crankshaft conrod journal
16 larger piston crankshaft conrod journal
17 total crankshaft

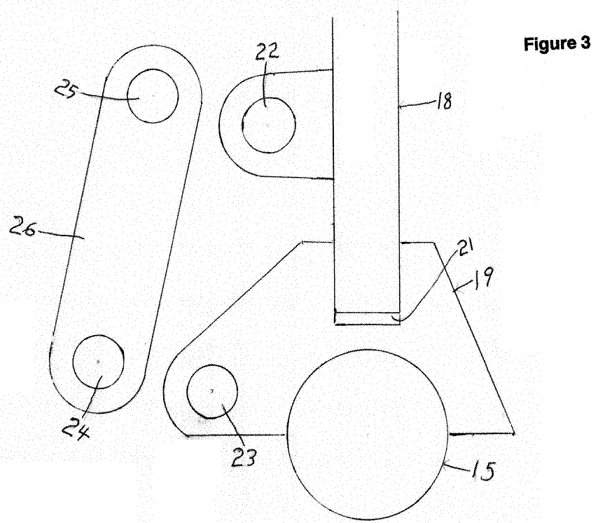

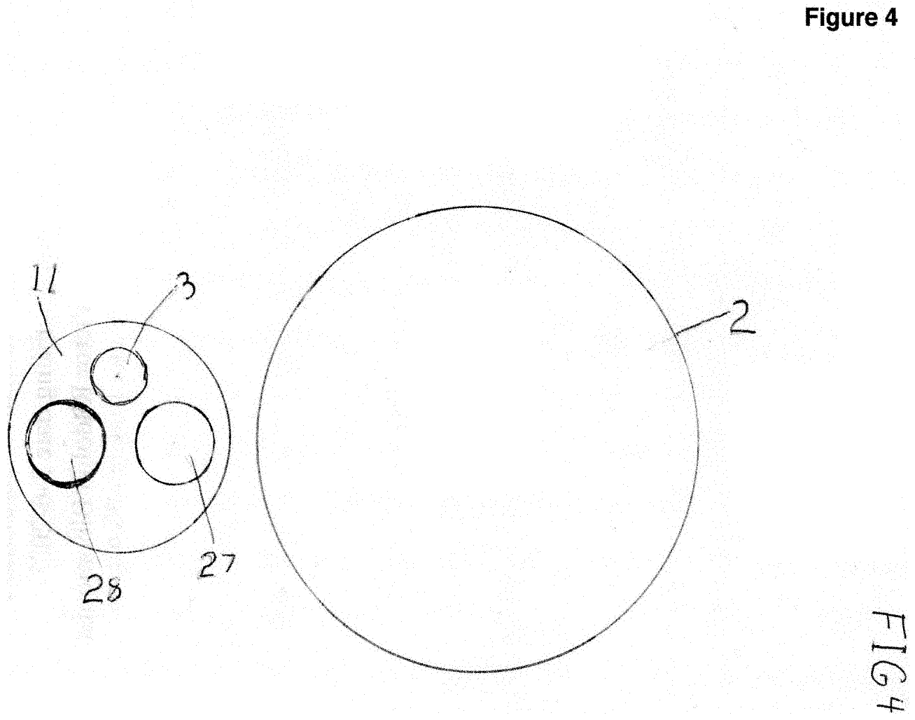

FIG. 3:
18 ignition piston conrod
19 receptacle for the conrod and thrust rod
21 empty space under the lower end of the conrod
22 conrod thrust rod receptacle pinhole
23 crankshaft mounted receptacle pinhole for the thrust rod
24 lower connecting pinhole in the thrust rod
25 upper connecting pinhole in the thrust rod
26 thrust rod FIG. 4:
27 ignition piston intake valve
28 ignition piston exhaust valve

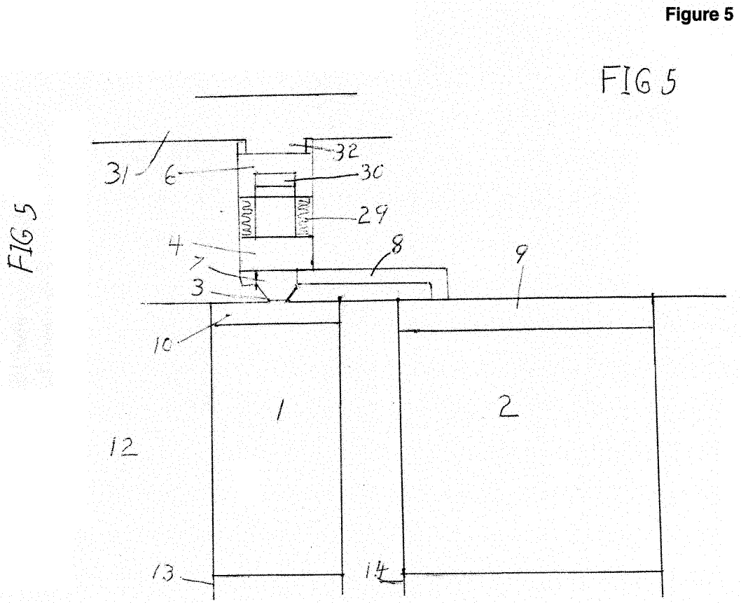

FIG. 5:
3 relief timing valve
29 relief timing valve compression spring
6 relief timing valve pressure adjusting cylinder
30 airspace
31 timing camshaft
32 The protrusion or cam part of the camshaft

FIG. 6:
33 intake valve for channel 8

### BRIEF DESCRIPTION

### Ignition Piston

It is two parallel adjacent cylinders with pistons; one (cylinder piston unit) small and one large. The small piston (the ignition piston) compresses the fuel-air mixture to combustion which opens a relief valve. The relief valve opens a channel between the two pistons' combustion chambers. The burning air-fuel mixture is forced through the channel; thus igniting the fuel load. The whole operation taking place without a spark plug or injector. Also, take note of the new idea conrod that puts piston push torque after top dead center; When the crank journal is before top dead center. Also, the relief valve can be used for timing the ignition piston.

1. An internal combustion engine piston operation compromising; two parallel pistons adjacent to each other driven by the same crankshaft stroking in unison; one piston small and other large; the large has low compression approximately eight to one; the small piston has high diesel type compression; when the large piston is past top dead center eight degrees and the small piston is eight degrees before top dead center; the small ignition piston 1 compresses the fuel-air mixture to combustion; a relief valve 3 in the head 11 above the small piston is forced open by the combustion pressure; when the relief valve 3 is forced up it leaves an open channel 8 in the head over to the combustion chamber 9 of the low compression large piston 2; the combustion fire from the high-pressure small piston 1 travels through the channel 8 over to the combustion chamber 9 of the large piston 2; the fire entering the large piston combustion chamber 9 causes the air-fuel mixture to explode;

2. Because ignition is accomplished by compression there is no spark plug electrical system or a high-pressure injector system.

3. A new design conrod 18 for the high compression ignition piston 1; it puts the piston push torque past the top dead center even when the conrod crankshaft journal 15 is eight degrees before the top dead center.
